(19) United States
(12) Patent Application Publication
(10) Pub. No.: US 2024/0124302 A1
(43) Pub. Date: Apr. 18, 2024

(54) PROCESS FOR PRODUCING LOW CARBON HYDROGEN

(71) Applicant: L'Air Liquide, Société Anonyme pour l'Etude et l'Exploitation des Procédés Georges Claude, Paris (FR)

(72) Inventors: Aditya SINGH, Frankfurt am Main (DE); Martin GORNY, Eschborn (DE); Pierre-Philippe GUERIF, Houston, TX (US)

(21) Appl. No.: 18/379,792

(22) Filed: Oct. 13, 2023

Related U.S. Application Data
(60) Provisional application No. 63/417,133, filed on Oct. 18, 2022.
(60) Provisional application No. 63/417,139, filed on Oct. 18, 2022.

(51) Int. Cl. C01B 3/34

(52) U.S. Cl. CPC C01B 3/34; C01B 2203/0205; C01B 2203/0283; C01B 2203/0475; C01B 2203/1211; C01B 2203/148; C01B 2203/1647; C01B 2203/1671; C01B 2203/169; C01B 2203/82; C01B 2203/86; C01B 2210/0051

(57) ABSTRACT

Low carbon hydrogen will play a crucial role in decarbonization of chemical complexes and manufacturing facilities. Depending on the application, different grades of low carbon hydrogen might be required—fuel grade (90-99% H2 purity) or chemical grade (>99% H2 purity). The current invention describes a hydrogen production process based on autothermal reforming and CO2 capture to produce low carbon hydrogen with hydrogen rich offgas as part of the feedstock.

### CROSS REFERENCE TO RELATED APPLICATIONS

This application claims the benefit of priority under 35 U.S.C. § 119 (a) and (b) to U.S. Provisional Patent Application Nos. 63/417,133 and 63/417,139, both filed Oct. 18, 2022, the entire contents of which are incorporated herein by reference.

### BACKGROUND

### State of the Art

Conventionally hydrogen has been produced from hydrocarbon sources using steam methane reforming. Most of the application for industrial hydrogen was as a utility in chemical complexes. A traditional SMR process involved syngas (H2+CO+CO2) generation in a steam methane reformer. This was followed by a water gas shift section where CO was shifted to CO2 in order to maximize the H2 production. The shifted syngas was sent to a purification unit (typically PSA) to recover high purity H2 (normally 99.9 mol % H2).

For decarbonization of industrial complexes, hydrogen is also being considered as a fuel for the crackers and fired heaters. The purity requirement for these applications is generally lower (96-98 mol % H2). The cracker produces some offgas containing 20-80% hydrogen with the rest as hydrocarbon, which can be recycled back to the hydrogen generation unit as a feedstock.

Hydrogen is also required for the production of fuels based on renewable feedstocks. An example of such fuel is sustainable aviation fuel (SAF), which is being increasingly adopted by major airlines in an effort to decarbonize traveling. The main advantage of renewable fuels is that they are fully compatible with existing engines and can be used as drop-in fuel to any extent. Production of such fuels generates off gases rich in hydrogen, which can be integrated with a hydrogen production unit for better efficiency. Furthermore, carbon capture on such a hydrogen generation unit with renewable offgas would mean that the net carbon intensity of the process is negative. Hydrogen for this application needs to have high purity (>99.9%) thus requiring a PSA in the hydrogen plant.

The conventional H2 production process described without any carbon capture based on steam methane reforming results in 9-11 kg CO2 in direct emissions for every kg H2 produced. As more hydrogen production facilities are set up during the transition to hydrogen economy, the corresponding CO2 emissions from traditional layouts will defeat the purpose of hydrogen manufacture. So there is an urgent need to decarbonize hydrogen production.

One way to decarbonize hydrogen production is to install a CO2 capture unit on the shifted syngas. This may be wash technology (physical or chemical) or cryogenic separation. The direct CO2 emissions can be reduced by 50-60% using this approach.

An alternative to steam methane reforming is autothermal reforming, where oxygen provides the heat for reaction in the ATR reactor. Due to significantly reduced fuel requirement, the direct CO2 emissions can be reduced by greater than 90% by installation of a CO2 capture unit on the shifted syngas. Another advantage of ATR is that the fuel-grade H2 production can also be done without a purification step (e.g. PSA), using a wash technology (physical or chemical) for CO2 removal. As a result, autothermal reforming seems the best option for feasible production of decarbonized hydrogen, especially at large scale.

### Disadvantages and/or Problems Resulting from State of the Art

The easiest way to integrate hydrogen rich offgas as a feedstock in an ATR-based H2 plant with carbon capture is to use it as feed or a part of feed. However, this is CAPEX-intensive since all the hydrogen present in the off gases simply increases the system volume.

Based on the application, two different hydrogen grade requirements (chemical grade and fuel grade) are setting the requirement for decarbonized hydrogen. It might be very much possible that the same industrial complex will require simultaneous production of both grades of hydrogen. However conventional modes of hydrogen production will mean that separation hydrogen units will be required for different hydrogen purity grades.

### Task/Approach to Solve a Problem

Instead of mixing directly with feed, the hydrogen rich offgases can be sent to a hydrogen purification step where a significant amount of hydrogen can be recovered as a part of the product requirement. Doing so helps to avoid increasing the volume of the whole system and thus offers an attractive solution.

Additionally, instead of a separate hydrogen units to produce different grades, the current invention describes configurations to make multiple hydrogen grades from the same unit. This is done by utilizing the commonalities of the hydrogen production process, and trying to have as many common units as possible. The result is a layout significantly cheaper than 2 separate hydrogen units, with the possibility of flexibility of switching from one grade to another during operation.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic representation of wash technology, in accordance with one embodiment of the present invention.

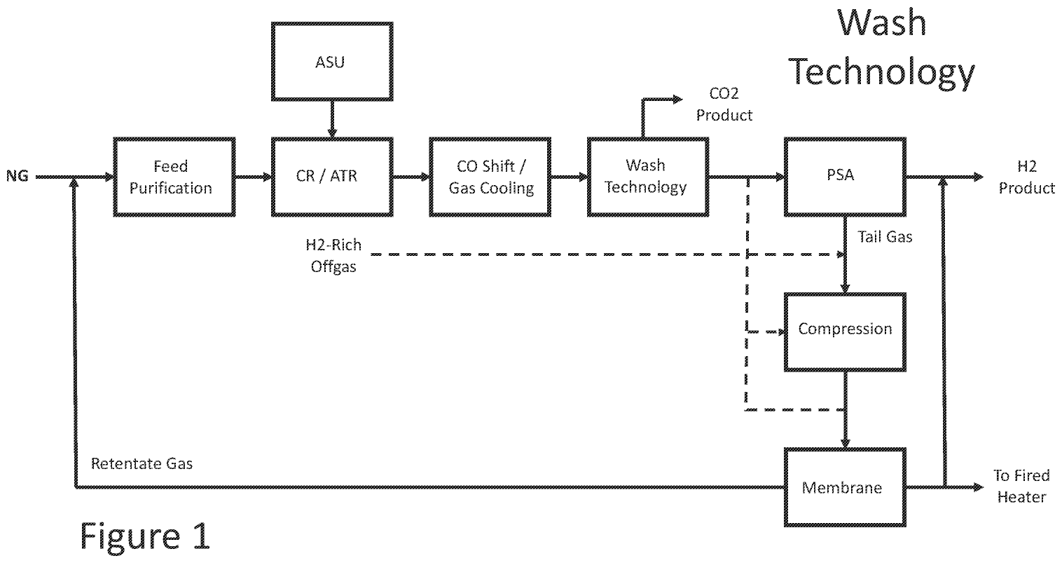

FIG. 2 is a schematic representation of cryogenic technology, in accordance with one embodiment of the present invention.

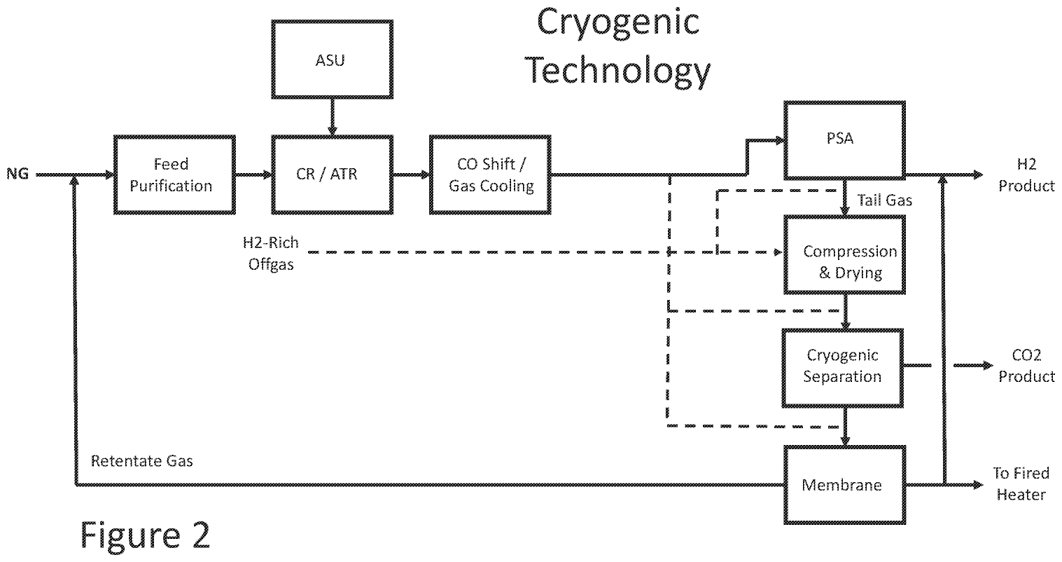

FIG. 3 is a schematic representation of combined wash technology and cryogenic technology, in accordance with one embodiment of the present invention.

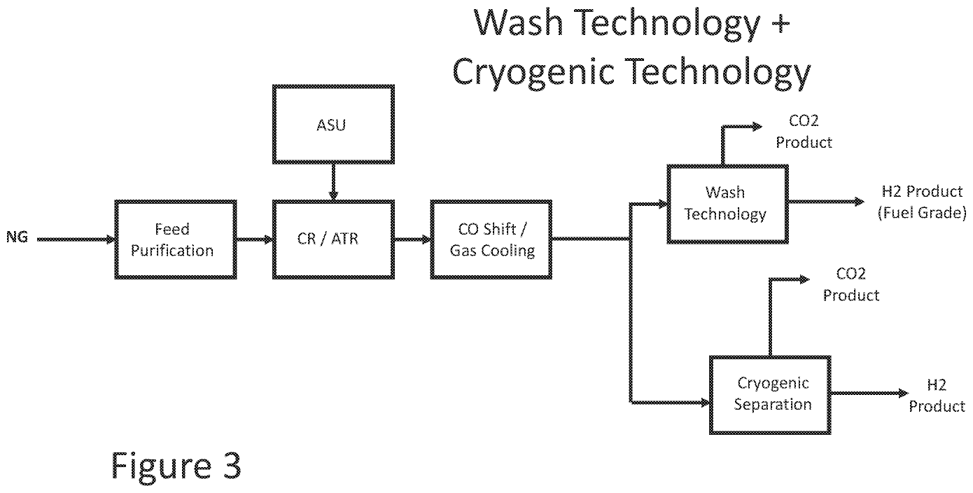

FIG. 4 is another schematic representation of wash technology, in accordance with one embodiment of the present invention.

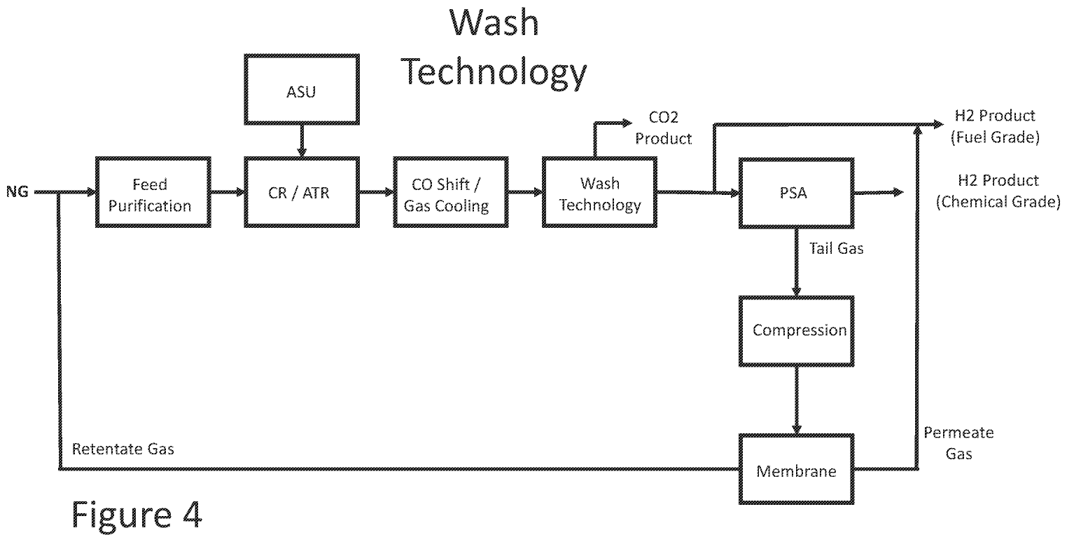

FIG. 5 is another schematic representation of cryogenic technology, in accordance with one embodiment of the present invention.

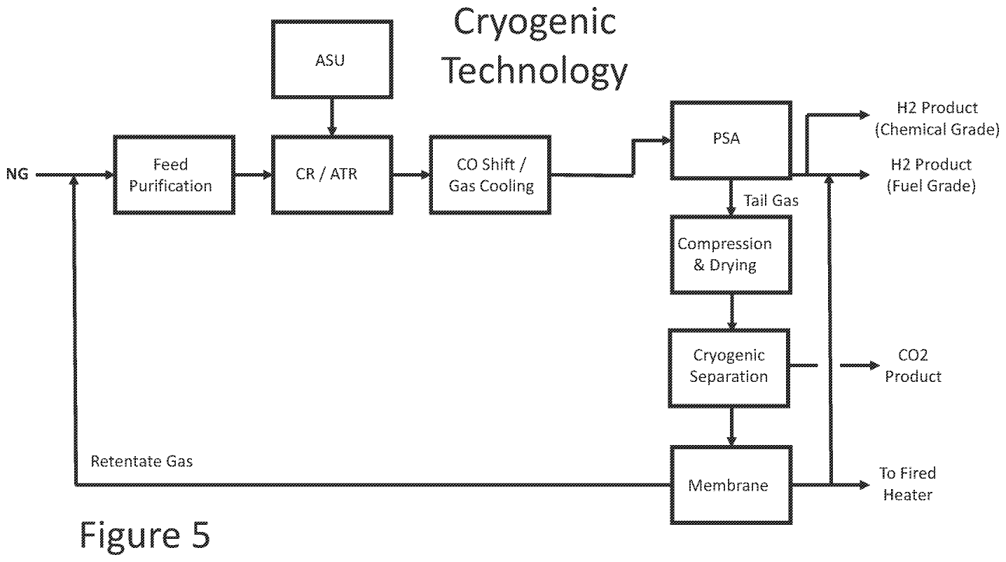

### DETAILED DESCRIPTION OF THE INVENTION

The current invention describes layouts to produce low carbon hydrogen from an ATR based hydrogen plant when at least one of the feedstock is a hydrogen-rich gas. Based on the type of CO2 capture technology, there can be different configurations:

The current invention describes layouts to produce multiple hydrogen units while utilizing the same syngas generation unit. Based on requirements, common or separate CO2 capture units may be used.

### Wash Technology (Physical or Chemical)

In this scheme, the shifted syngas is sent to a single CO2 removal unit based on wash technology (physical or chemical). The CO2-free syngas at the outlet of the CO2 removal unit based on wash technology generally has 98 dry mol % H2 purity, and can be used directly as fuel grade H2. For hydrogen requirement with more than 99% purity, the syngas from the CO2 removal unit is sent to a purification unit (typically a PSA).

If the hydrogen rich offgas is at a moderate pressure (>20 barg), then it can be sent directly to PSA.

If the pressure is much lower, then the gas needs to be compressed. For ATR-based low carbon H2 layouts, the PSA tail is also rich in hydrogen (70-90%) and at low pressure (1-2 bar abs). So the H2-rich off gases can be combined with the PSA tail gas and sent to a purification step (e.g. membrane) to recover hydrogen.

In this scheme, shifted syngas is split into 2 separate CO2 removal units—one based on wash technology (physical or chemical) and the other based on cryogenic separation. The advantage of this approach is that in case only 1 grade of H2 is required at a particular point of time, then one of the CO2 removal units can be shut down, thus giving us operational flexibility.

The CO2-free syngas at the outlet of the CO2 removal unit based on wash technology generally has 98 dry mol % H2 purity, and can be used directly as fuel grade H2.

The CO2 removal unit based on cryogenic separation has a PSA as the first step, so the hydrogen product can be 99.9% pure H2 and used as chemical grade H2.

### Wash Technology (Physical or Chemical)

In this scheme, the shifted syngas is sent to a single CO2 removal unit based on wash technology (physical or chemical). The CO2-free syngas at the outlet of the CO2 removal unit based on wash technology generally has 98 dry mol % H2 purity, and can be used directly as fuel grade H2. For hydrogen requirement as chemical grade, the necessary split can be taken from the CO2 removal unit and sent to a purification unit (e.g. PSA).

### Cryogenic Separation

Advantage of CO2 removal based on cryogenic separation is that CO2 can be recovered at a higher pressure as compared to wash technology (physical or chemical) or even as a liquid product. For a CO2 removal unit based on cryogenic separation, the first step is hydrogen purification by PSA followed by CO2 removal from the PSA tail gas. For this, the compressed and dried tail gas is sent to cryogenic CO2 separation. The H2-rich recycle gas from the cryogenic CO2 separation contains 70-85% H2. The H2-rich off gases from outside BL can be mixed here and sent to a common purification step (like membrane) to recover hydrogen.

The combined feed of natural gas and hydrogen rich off gas in one plant is favorable, compared to individual handling, as the hydrogen produced can be used in the facility that generates the off-gas. However, as off gas production and hydrogen demand are rarely matching, natural gas can be used to balance product demand and feedstock supply. Using one facility as well helps to reduce material required for the facility construction and thus minimizes full project life time CO2 (e.g.) emissions.

Surprisingly subjecting the PSA tail gases to a membrane unit for hydrogen enrichment compared to the classical routing back to the ATR and/or using as fuel, helps to improve the overall CC rate as the hydrogen rich stream can be used as product/fuel with low carbon intensity. At the same time reducing the hydrogen content in the carbon rich stream sent to the ATR helps to reduce the size of the reforming equipment as less hydrogen (that acts nearly as an inert in the reforming) is routed through the reforming section.

Advantage of CO2 removal based on cryogenic separation is that CO2 can be recovered at a higher pressure as compared to wash technology (physical or chemical) or even as a liquid product. For a CO2 removal unit based on cryogenic separation, the first step is hydrogen purification by PSA followed by CO2 removal from the PSA tail gas. For this, the compressed and dried tail gas is sent to cryogenic CO2 separation. The H2-rich recycle gas from the cryogenic CO2 separation contains 70-85% H2. For the fuel grade H2, this H2-rich recycle gas can be blended with the chemical grade H2 from the PSA to achieve the desired purity requirement.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A process based on autothermal reforming using at least one hydrogen rich off-gas for production of low carbon hydrogen with a minimum 99% hydrogen purity on a dry basis, utilizing a carbon dioxide removal unit based on wash technology followed by a PSA, comprising:
a. operating at least one autothermal reforming reactor at steam to carbon ratio at the reactor ranging from 0.4-2.0, thereby producing a raw syngas stream,
b. introducing the raw syngas stream into at least one water gas shift reactor; thereby producing a shifted syngas stream,
c. introducing at least a fraction of the shifted syngas stream into a carbon dioxide removal unit based on wash technology, thereby producing a washed syngas stream,
d. introducing at least a fraction of the washed syngas stream into a carbon dioxide removal unit based on cryogenic separation; thereby producing a hydrogen-rich syngas stream, with a minimum of 95% hydrogen purity on a dry basis,
e. introducing the hydrogen-rich syngas stream into a purification unit pressure swing adsorption unit (PSA), thereby producing a hydrogen stream with a min. 99% hydrogen purity on a dry basis and a hydrogen rich tail gas stream,
f. combining one or more hydrogen rich off gas streams with at least a part of the PSA tail gas stream, and sending the combined stream to a membrane separator thereby producing a hydrogen-rich permeate stream and a retentate stream,
wherein the hydrogen-rich permeate stream contains 60-97 mol % hydrogen and is used for fuel purpose in a fired heater or exported outside battery limits or both, while the retentate gas is recycled upstream of the autothermal reforming reactor.

2. The process of claim 1, wherein the hydrogen rich off gases being sent to the PSA directly and not being mixed with the PSA tail gas.

3. A process based on autothermal reforming using at least one hydrogen rich off-gas for production of low carbon hydrogen with a minimum 99% hydrogen purity on a dry basis, utilizing a carbon dioxide removal unit, based on cryogenic separation, comprising:
a. operating at least one autothermal reforming reactor operating at steam to carbon ratio at the reactor ranging from 0.4-2.0, thereby producing a raw syngas stream,
b. introducing the raw syngas stream into at least one water gas shift reactor; thereby producing a shifted syngas stream,
c. introducing at least a fraction of the shifted syngas stream into a carbon dioxide removal unit based on cryogenic separation, thereby producing a PSA tail gas stream,
the cryogenic separation comprising a PSA, PSA tail gas compression and drying, and a cryogenic process for carbon dioxide removal from the PSA tail gas,
d. mixing one or more hydrogen rich off gases with at least part of the PSA tail gas stream and introducing the combined stream into a membrane separation unit, thereby producing a hydrogen stream, and a hydrogen rich tail gas stream,
wherein the hydrogen-rich permeate gas from the membrane, contains 60-97 mol % hydrogen and is used for fuel purpose in the fired heater or exported outside battery limits or sent to PSA inlet or more than one of these options while the retentate gas is recycled upstream the autothermal reforming reactor.

4. The process of claim 3, wherein the hydrogen rich off gases being sent to the PSA directly and not being mixed with the PSA tail gas.

5. A process based on autothermal reforming for production of two grades of low carbon hydrogen, the first a fuel grade with a minimum 95% hydrogen purity on a dry basis and the second a chemical grade with minimum 99% hydrogen purity on a dry basis, utilizing two different carbon dioxide removal units, one based on wash technology and other based on cryogenic separation, comprising:
a. operating at least one autothermal reforming reactor operating at steam to carbon ratio at the reactor ranging from 0.4-2.0, thereby producing a raw syngas stream,
b. introducing the raw syngas stream into at least one water gas shift reactor; thereby producing a shifted syngas stream,
c. introducing at least a fraction of the shifted syngas stream into a carbon dioxide removal unit based on wash technology, thereby producing a washed syngas stream,
d. introducing at least a fraction of the washed syngas stream into a carbon dioxide removal unit based on cryogenic separation; thereby producing a hydrogen-rich syngas stream, with a minimum of 99% hydrogen purity on a dry basis,
e. exporting at least a fraction of the washed syngas stream as fuel-grade hydrogen,
f. exporting at least a fraction of the hydrogen-rich syngas stream as chemical-grade hydrogen.

6. The process of claim 5, with full flexibility to adjust the production rate of each hydrogen grade individually, from zero to the design capacity.

7. A process based on autothermal reforming for production of two grades of low carbon hydrogen, the first being a fuel grade with a minimum of 95% hydrogen purity on a dry basis and the second being a chemical grade with a minimum 99% hydrogen purity on a dry basis, utilizing a single type of carbon dioxide removal unit, based on wash technology, comprising:
a. operating at least one autothermal reforming reactor operating at steam to carbon ratio at the reactor ranging from 0.4-2.0, thereby producing a raw syngas stream,
b. introducing the raw syngas stream into at least one water gas shift reactor; thereby producing a shifted syngas stream,
c. introducing at least a fraction of the shifted syngas stream into a carbon dioxide removal unit based on wash technology, thereby producing a washed syngas stream,
d. exporting at least a fraction of washed syngas stream as fuel-grade hydrogen,
e. introducing at least a fraction of the washed syngas stream into a purification unit thereby producing a chemical-grade hydrogen with a minimum 99% hydrogen purity on a dry basis.

8. The process of claim 7, with full flexibility to adjust the production rate of each hydrogen grade individually, from zero to the design capacity.

9. The process of claim 7, comprising blending at least a fraction of the PSA tail gas, containing 65-95% hydrogen on a dry basis, in the fuel-grade hydrogen product.

10. The process of claim 7, wherein the compressed PSA tail gas is sent to a membrane purification unit, and blending at least a fraction of the hydrogen-rich membrane permeate gas, containing 80-98% hydrogen on a dry basis, in the fuel-grade hydrogen product, and recycling the membrane retentate gas back to the process at a point upstream the autothermal reforming reactor.

11. The process of claim 7, wherein all the hydrogen-rich syngas, with a minimum of 95% hydrogen purity on a dry basis, from the outlet of carbon dioxide removal unit based on wash technology sent to a purification unit thereby producing a chemical-grade hydrogen with a minimum. 99% hydrogen purity on a dry basis, sending the compressed PSA tail gas to a membrane purification unit, the hydrogen-rich membrane permeate gas is exported as fuel-grade hydrogen product, the membrane retentate gas is recycled back to the process at a point upstream the ATR.

12. A process based on autothermal reforming for production of two grades of low carbon hydrogen, the first being a fuel grade with a minimum 95% hydrogen purity on a dry basis and the second being a chemical grade with a minimum 99% hydrogen purity on a dry basis, utilizing a single type of carbon dioxide removal unit, based on cryogenic separation, comprising
a. operating at least one autothermal reforming reactor operating at steam to carbon ratio at the reactor ranging from 0.4-2.0, thereby producing a raw syngas stream,
b. introducing the raw syngas stream into at least one water gas shift reactor; thereby producing a shifted syngas stream,
c. introducing at least a fraction of the shifted syngas stream into a carbon dioxide removal unit based on cryogenic separation, thereby producing a PSA tail gas stream,
d. blending at least a fraction of the hydrogen-rich syngas, with 60-80% hydrogen purity on a dry basis, into the fuel-grade hydrogen product,
e. blending at least a fraction of hydrogen-rich syngas from the PSA with min. 99% hydrogen purity on a dry basis, into the fuel-grade hydrogen product, and
f. exporting at least a fraction of hydrogen-rich syngas from the PSA with a minimum 99% hydrogen purity on a dry basis, as chemical-grade hydrogen product.

13. The process of claim 12, comprising sending at least a fraction of the hydrogen-rich syngas, with 60-80% hydrogen purity on a dry basis, from the cryogenic carbon dioxide separation of the PSA tail gas, to a membrane separation unit, with the hydrogen-rich permeate gas being blended with the fuel-grade hydrogen, and recycling the membrane retentate gas back to the process at a point upstream the autothermal reforming reactor.
